(19) United States
(12) Patent Application Publication
(10) Pub. No.: US 2021/0031357 A1
(43) Pub. Date: Feb. 4, 2021

(54) CHAINSAW CHAIN STORAGE CONTAINER

(71) Applicant: Thomas Baker, Adams, OR (US)

(72) Inventor: Thomas Baker, Adams, OR (US)

(21) Appl. No.: 16/943,777

(22) Filed: Jul. 30, 2020

Related U.S. Application Data
(60) Provisional application No. 62/880,368, filed on Jul. 30, 2019.

(51) Int. Cl. B25H 3/02; B65D 21/02; B27B 17/00

(52) U.S. Cl. CPC B25H 3/02; B27B 17/00; B65D 21/0204

(57) ABSTRACT

A container configured for storing a chainsaw chain and method for storing a chainsaw chain. The method requires a chainsaw chain and a container. The container has chamber configured to secure the width of a chainsaw chain. The container may have variable height and length but the width of the chamber in the container must be approximately that of the width of the chainsaw chain. The chainsaw chain is loaded into the storage container vertically so that the width of the chain securely fits into the width of the chamber. The length of the chain folds or bunches onto itself so as to planarly stack in the storage container. This container and method is intended to prevent tangling of the chainsaw chain and allows for efficient storage of the chainsaw chain.

### PRIORITY/CROSS-REFERENCE TO RELATED APPLICATIONS

This application claims the benefit of U.S. Provisional Application No. 62/880,368, filed Jul. 30, 2019, the disclosure of which is incorporated by reference.

### TECHNICAL FIELD

The presently disclosed technology relates generally to an apparatus for storing one or more chainsaw chains and a method of storing chainsaw chains, and more specifically to an apparatus for storing one or more chainsaw chains and method of storing chain saw chains by stacking the chain saw chain in a storage container configured to reduce tangling of the chainsaw chain.

### BACKGROUND

Chainsaws are portable mechanical saws which cut with a rotating chain that is driven along a guide bar. The chain is generally formed of steel links that contain cutting teeth connected by rivets. The chain superficially resembles a bicycle-style roller chain. The cutting teeth that are used to cut the intended object are on the outside of the chain loop. The inside of the chain loop generally has flat drive links to retain the chain on the saw's bar and allows propulsion by the engine or motor of the chainsaw. A chainsaw chain is typically removable from the guide bar allowing chainsaw users to replace the chain in use if it wears out or breaks. Often a user will carry additional chains in the event of a breakage. It is preferable to keep chainsaw chains clean and rust free. One problem that often arises with the extra chainsaw chains is that the chains can become tangled or twisted in storage. The chains become tangled or twisted when the links are positioned in a side by side orientation with the links crossing over one another. When the links of the chain cross over each other, the sharp teeth of the chain are typically damaged.

What is needed is an apparatus and a method for storing one or more chainsaw chains that prevents the chainsaw chain from tangling while also keeping the chain clean, dry, and rust free, while providing compact and easy transport in storage.

### SUMMARY OF THE INVENTION

The purpose of the summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the inventive concept(s) of the application, which is measured by the claims, nor is it intended to be limiting as to the scope of the inventive concept(s) in any way.

What is disclosed is a container configured for storing at least one chainsaw chain. The container preferably has the dimensions of a box, with a width, a height, and a length. The container has a first side wall and a second side wall defining an internal chamber. The container defines an opening at one end. The opening extends into an internal chamber. The internal chamber has a width that is substantially similar to the width of a chain saw such that when the chainsaw chain is loaded into the chamber, the length of the chain folds or bunches onto itself so as to planarly stack in the storage container. The first face and second face of the chainsaw chain are configured to be positioned proximate to the first side wall and second side wall, respectively, preventing the chain links from stacking in a second plane and becoming tangled. The first face and the second face of the chainsaw chain are positioned in a generally linear orientation in a linear and planar orientation in the chamber.

The container and the internal chamber may have variable height and length. The width of the chamber is approximately the width of the chainsaw chain so that the chainsaw chain securely fits within the storage container and the chainsaw chain cannot shift to the side of an already placed portion of the chain. In a preferred embodiment, the width of the chamber is approximately five-sixteenth inches ( 5/16″). The internal chamber is configured to prevent the chain links from tangling and crossing over one another, reducing the damage to the teeth of the chainsaw chain.

What is further disclosed is a method for storing a chainsaw chain. The method utilizes a chainsaw chain and a container. The container preferably has the dimensions of a box, with a width, a height, and a length. The container preferably defines an opening at one end. The opening extends into an internal chamber in the container. The internal chamber has a width that is substantially similar to the width of a chain saw such that when the chainsaw chain is loaded into the chamber, the length of the chain folds or bunches onto itself so as to planarly stack in the container.

The chainsaw chain is loaded into the container vertically so that the width of the chain securely fits into the width of the chamber. The length of the chain folds or bunches onto itself so as to planarly stack in the storage container. The width of the chamber is intended to prevent tangling of the chainsaw chain and allows for efficient storage of the chainsaw chain. The first face and second face of the chainsaw chain are configured to be positioned proximate to the first side wall and second side wall, respectively, preventing the chain links from stacking in a second plane and becoming tangled. The first face and the second face of the chainsaw chain are positioned in a generally linear orientation in a linear and planar orientation in the chamber.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the description of the preferred embodiments are to be regarded as illustrative in nature, and not as restrictive in nature.

### BRIEF DESCRIPTION OF DRAWINGS

FIG. 1 is an exploded view of an embodiment of a chainsaw storage container and a chainsaw chain.

FIG. 2 is a front view of a chainsaw chain and a chainsaw storage container with chainsaw chain being inserted into a chainsaw storage container.

FIG. 3 is a front view of a chainsaw chain and a chainsaw storage container with chainsaw chain partially inserted into a chainsaw storage container.

FIG. 4 is a front view of a chainsaw chain and a chainsaw storage container with chainsaw chain fully inserted into a chainsaw storage container.

FIG. 5 is front perspective view of two chainsaw chains and two chainsaw chain storage container connected.

FIG. 6 is a front perspective view of two separated chainsaw chain storage containers.

### DETAILED DESCRIPTION

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

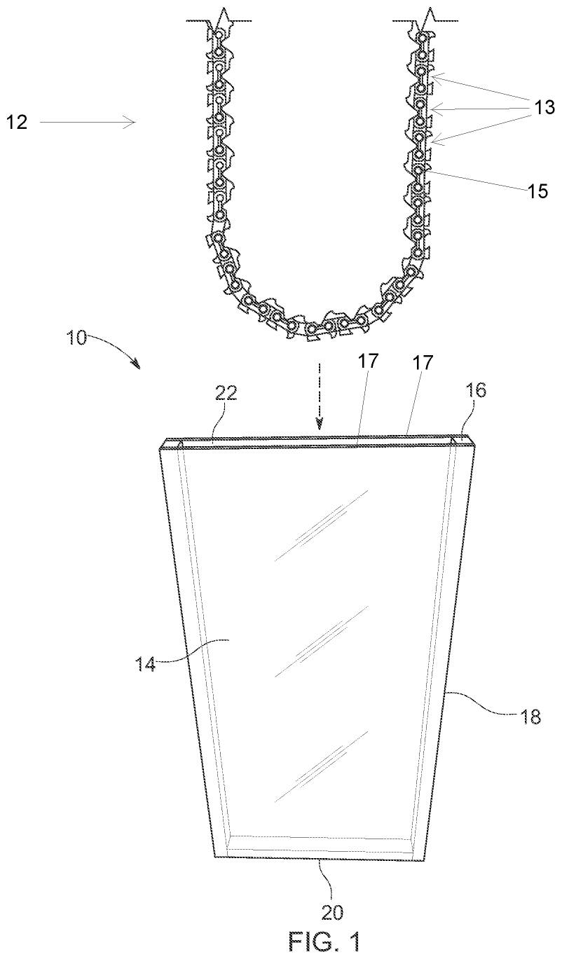

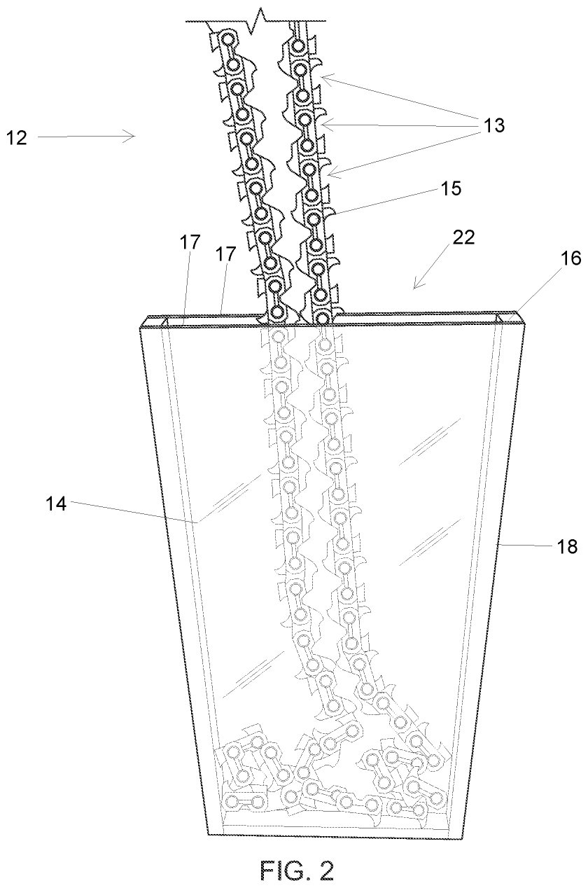

FIG. 1 depicts the chainsaw chain 12 and a storage container 14. The chainsaw chain has a plurality of links 13. The container 14 preferably has the dimensions of a box with a width 16, a height 18, and a length 20. In a preferred embodiment, the height 18 of the storage container is ten inches (10″) and the length 20 is five inches (5″). In alternate embodiments the height and length of the storage container may vary based on the preferences of the user. In a preferred embodiment, the width is approximately five-sixteenth inches ( 5/16″) and configured so that the chainsaw chain securely fits within the storage container and the chainsaw chain cannot slide past another chain length (illustrated in FIGS. 2-4). The width size may vary marginally provided the width of the chainsaw chain is prevented from moving to a side by side orientation. In alternate embodiments, the width of the container may increase to be configured for larger chainsaw chains.

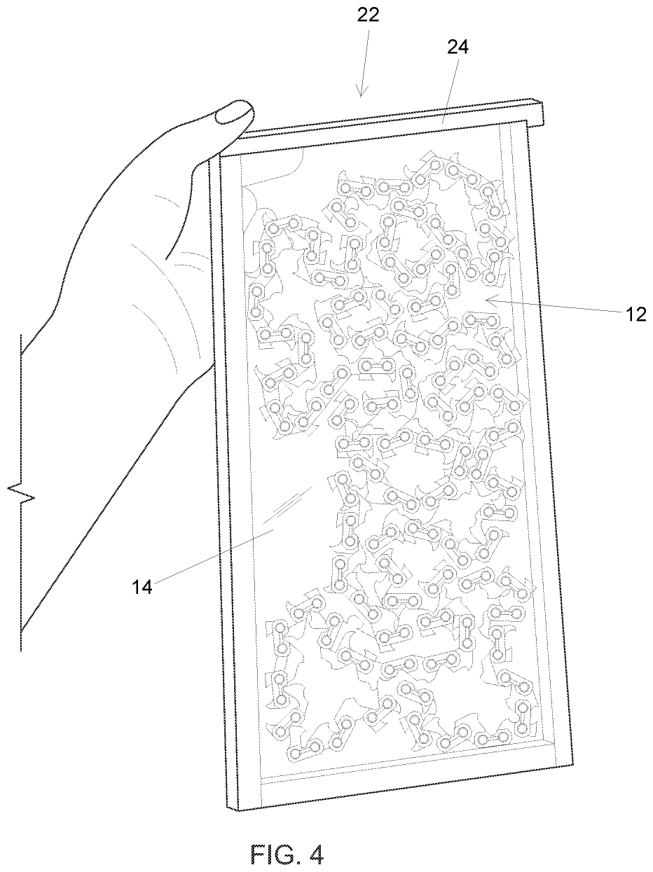

In a preferred embodiment, the storage container 14 has an opening 22 at the top of the storage container 14 so that a chainsaw chain 12 can be inserted or stacked into the opening. As the chain 12 is inserted into the opening 22 it folds or stacks on itself vertically up the height 18 of the storage container 14. The width 16 of the opening 16 is approximately five-sixteenth inches ( 5/16″) and is configured so that a chainsaw chain 12 can only stack in a generally planar direction. The face 15 of the link 13 is configured to be generally proximate or abut the opposing walls 17 of the storage container 14. In alternate embodiments, a lid (illustrated in FIG. 4) can attach to the opening 22 in order to seal the contents of the storage container.

FIG. 2 depicts a chainsaw chain 12 being inserted into the container 14 vertically from above. The chainsaw chain folds on itself when it reaches the bottom of the storage container, stacking in a generally planar direction along the height 18 and length 16 of the container 14. The width 16 of the container 14 is configured to stack the chainsaw chain 12 in a generally planar direction. The face 15 of the links 13 are generally proximate to or abutting the opposing walls 17 of the storage container 14.

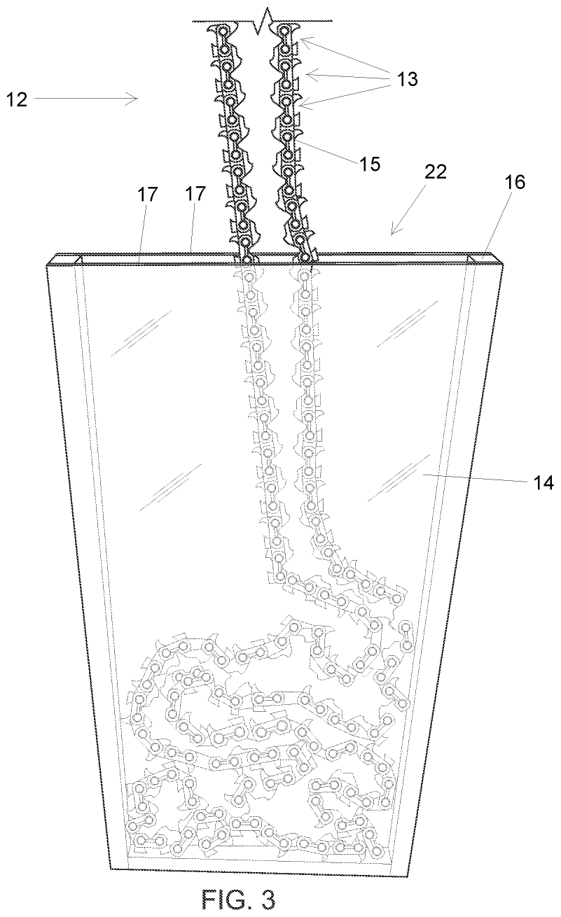

FIG. 3 depicts the chainsaw chain folding as it is further inserted into the opening 22 of the container 14. The chainsaw chain 12 stacks on itself and the width 16 of the container 14 causes the chainsaw chain 12 to stack in a generally planar direction. The face 15 of the links 13 are generally proximate to or abutting the opposing walls 17 of the storage container 14.

FIG. 4 depicts a chainsaw chain 12 entirely inserted into the chainsaw chain storage container 14. The chain 12 is stacked on itself and the width 16 prevents the chainsaw chain from sliding to the side of an already placed chain length in order to prevent tangling of the chainsaw chain 12. The chainsaw chain 12 is positioned in a generally planar direction, with the face of the links generally abutting the opposing side walls of the storage container 14. In this embodiment, a lid 24 is configured to attach to the top of the container 14 to cover the opening 22. The lid 24 is configured to allow a user to transport the container 14 without the chainsaw chain 12 being displaced.

In an alternate embodiment, the storage container can be configured to have multiple openings creating multiple chambers to store multiple chains using the method.

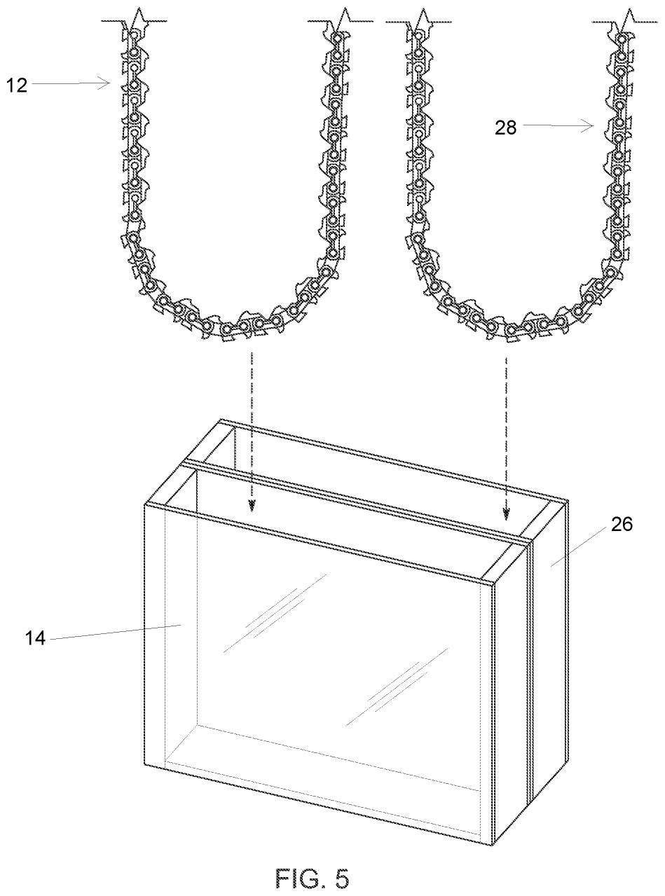

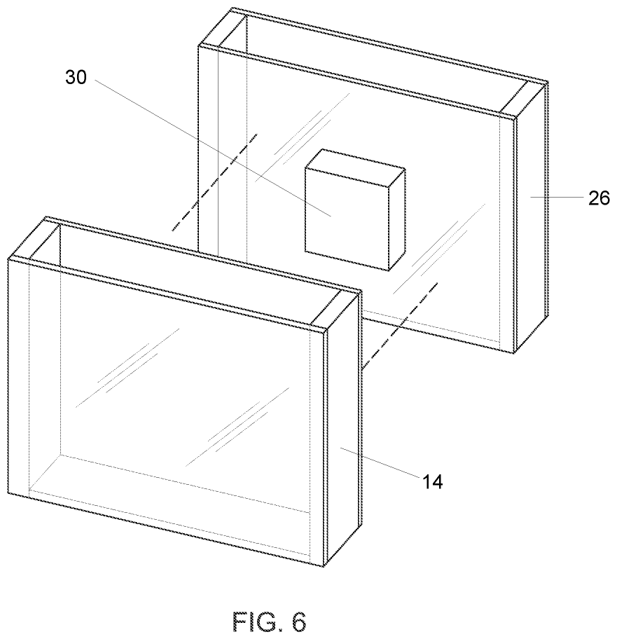

Alternatively, as depicted in FIGS. 5 and 6, the container can be constructed to attach a second storage container 26 in order to store a second chain 28. The storage containers 14, 26 can be configured for quick attachment to further containers to store as many chains as required by a user. The storage containers 14, 26 preferably utilize an attachment mechanism 30, such as a snap fit attachment, hook and loop fasteners, clasps, attachment clamps, or other attachment mechanisms known in the art. The storage containers 14, 26 are configured to secure to one another and can be easily separable, allowing for multiple chains to be stored.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

I claim:

1. A storage container for storing a chainsaw chain, wherein said chainsaw chain comprises a plurality of chainsaw chain links, wherein said chainsaw chain defines a width between a first face of a chainsaw chain link and a second face of each of said plurality of chainsaw chain links, said storage container comprising:
a container, said container having a first side wall and a second side wall defining a chamber having a width, a length, and a height, wherein said container defines an opening into said chamber,
wherein said chamber is configured prevent said chainsaw chain from tangling, wherein said chamber width is configured to fit the width of said chainsaw chain, wherein said chamber is configured to planarly stack said chainsaw chain in said chamber such that said first face and said second face are positioned in a plane between said first side wall and said second side wall and said first face and said second face are prevented from stacking in a second plane and becoming tangled, wherein said chamber is configured such that said first face is configured to be positioned proximate to the interior surface of said first side wall and said second face is configured to be positioned proximate to the interior surface of said second side wall such that said first face and said second face of said plurality of chainsaw chain links are positioned in a linear orientation.

2. The storage container of claim 1, wherein said width of said chainsaw chain is 5/16 inches.

3. The storage container of claim 1, wherein said container is configured to attach to additional containers, wherein said additional containers are configured to store said chainsaw chain.

4. The storage container of claim 1, wherein said container comprises a lid configured to attach to said opening.

5. The storage container of claim 1, wherein said container comprises a plastic material.

6. The storage container of claim 1, wherein said container comprises a metal material.

7. A method of storing a chainsaw chain to prevent said chainsaw chain from tangling, said method comprising the following steps:
the step of providing a chainsaw chain, wherein said chainsaw chain comprises a plurality of chainsaw chain links, wherein said chainsaw chain defines a width between a first face of a chainsaw chain link and a second face of said chainsaw chain link;
the step of providing an container, said container defining a chamber, wherein said container defines an opening to said chamber, wherein said chamber has a width configured to fit said width of said chainsaw chain such that said chainsaw chain folds and stacks;
the step of inserting said width of said chainsaw chain into said chamber through said opening, such that said width of said chainsaw chain is secured in said chamber by said width of said container, such that said chainsaw chain planarly stacks and said chamber prevents said chainsaw chain from stacking in a second plane.

8. The method of claim 7 wherein said container is a box.

9. The method of claim 7 wherein said container comprises a plastic material.

10. The method of claim 7 wherein said container comprises a metal material.

11. The method of claim 7 wherein said container is configured to attach to additional containers, wherein said additional containers are configured to store said chainsaw chain.

12. The method of claim 7 wherein said width of said chamber is approximately 5/16 inches.

13. The method of claim 7 wherein said container comprises a lid configured to attach to said opening.

14. A method of storing a chainsaw chain to prevent said chainsaw chain from tangling, said method comprising the following steps:
the step of providing a chainsaw chain, wherein said chainsaw chain comprises a plurality of chainsaw chain links, wherein said chainsaw chain defines a width between a first face of a chainsaw chain link and a second face of said chainsaw chain link
the step of providing a box, said box having a height, a length, and a width, said box defining an opening, said opening spanning approximately said width, wherein said opening further comprises a chamber, said chamber spanning approximately said width, wherein said chamber is configured to secure said width of said chainsaw chain;
the step of inserting said width of said chainsaw chain into said chamber through said opening, such that said width of said chainsaw chain is secured in said chamber by said width of said container, such that said chainsaw chain planarly stacks and said chamber prevents said chainsaw chain from stacking in a second plane.

15. The method of claim 14 wherein said box is configured to attach additional boxes, wherein said additional boxes are configured for storing said chainsaw chain.

16. The method of claim 14 wherein said chainsaw chain width is 5/16 inches.

17. The method of claim 14 wherein said container comprises a plastic material.

18. The method of claim 14 wherein said container comprises a metal material.

19. The method of claim 14 wherein said container comprises a lid configured to attach to said opening.
